(19) United States
(12) Patent Application Publication
(10) Pub. No.: US 2013/0116429 A1
(43) Pub. Date: May 9, 2013

(54) Gadobutrol Preparation in a One-Pot Process by means of DMF Acetal and N-Methylimidazole

(71) Applicant: Johannes Platzek, Berlin (DE)

(72) Inventor: Johannes Platzek, Berlin (DE)

(73) Assignee: BAYER INTELLECTUAL PROPERTY GMBH, Monheim (DE)

(21) Appl. No.: 13/701,914

(22) PCT Filed: May 31, 2011
(86) PCT No.: PCT/EP11/58988

§ 371 Date: Jan. 22, 2013

(30) Foreign Application Priority Data
Jun. 4, 2010 (DE) 102010023105.3

(51) Int. Cl. C07F 5/00

(52) U.S. Cl. CPC C07F 5/00
USPC 540/465

(57) ABSTRACT

A process is described for preparation of the gadolinium complex of N-(1-hydroxymethyl-2,3-dihydroxypropyl)-1,4,7-triscarboxymethyl-1,4,7,10-tetraazacyclododecane “gadobutrol=Gadovist®” in a one-pot process by means of DMF acetal and N-methylimidazole. Gadovist is a gadolinium-containing contrast agent for nuclear spin tomography and has been approved since 2000 in Germany in the indication “contrast amplification in cranial and spinal magnetic resonance tomography”.

The invention relates to a process for the preparation of the gadolinium complex of N-(1-hydroxymethyl-2,3-dihydroxypropyl)-1,4,7-triscarboxymethyl-1,4,7,10-tetraazacyclododecane “gadobutrol=Gadovist®” in a one-pot process by means of DMF acetal and N-methylimidazole.

Gadovist is a gadolinium-containing contrast agent for nuclear spin tomography and has been approved since 2000 in Germany in the indication “contrast amplification in cranial and spinal magnetic resonance tomography”.

The MRT contrast agent Gadovist® 1.0 is one of the more recent developments in the field of gadolinium-containing MR contrast agents (EP 0448191 B1). It is used for investigations that require a high concentration of contrast agent—e.g. for the diagnosis of a stroke or for the investigation of blood vessels, e.g. in tumors.

The contrast-imparting effect is based on gadobutrol, a non-ionic complex consisting of gadolinium(III) and the macrocyclic ligand dihydroxy(hydroxymethyl)propyl-tetraazacyclododecanetriacetic acid (butrol).

Gadobutrol, at the clinically recommended doses, leads to a reduction in the relaxation times of protons in tissue water.

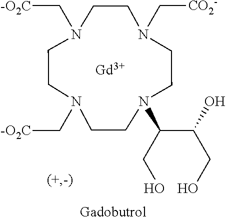

Due to their significance as diagnostic imaging agents, particularly in MRI diagnostics, various methods exist for the preparation of metal complexes, particularly the gadolinium complex, of N-(1-hydroxymethyl-2,3-dihydroxypropyl)-1,4,7-triscarboxymethyl-1,4,7,10-tetraazacyclododecane “gadobutrol” (DE 4009119).

Despite the advances achieved compared to the original methods, there still exists a need for environmentally friendlier and more cost effective synthesis options that are viable particularly on an industrial scale.

It has been found, surprisingly, that gadobutrol meeting the specifications can be prepared in a high yield without isolation of intermediates, starting from cyclen (1,4,7,10-tetraazacyclododecane) of formula 1 (DE19608307), which can now be bought under very favourable conditions, and thus are clearly superior to the methods

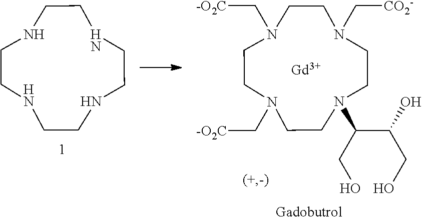

which involve intermediate isolation on intermediate purification, especially with respect to the throughput and production time. The inventive method is clearly superior to the closest prior art (Inorg. Chem. 1997, 36, 6086-6093 and DE 19724186.7) and to the method described in EP 1343770 B1, in which the butrol ligand is isolated as a lithium complex.

The document EP 0596586 B1 describes reacting cyclen, as starting material, with 4,4-dimethyl-3,5,8-trioxabicyclo[5.1.0]octane, and subsequently hydrolyzing the formyl intermediate by addition of water and lithium hydroxide, and then reacting with chloro- or bromoacetic acid, in which the bases lithium hydroxide or N-methylimidazole serve as scavengers, then acidifying in the same pot with hydrochloric acid or hydrobromic acid and complexing with gadolinium. The gadolinium complex precipitates on removal of solvent by distillation and addition of ethanol or isopropanol and is filtered off and, after brief interim cleaning of the reaction stirrer, is dissolved in water directly from the filter (still moist) and rinsed back into the stirrer to carry out a final crystallization from ethanol. The method does not use an ion-exchanger and also avoids the intermediate isolation of the butrol ligand in free form or else as the lithium complex, as described in EP 1343770 B1.

The advantages of this method are a high throughput without isolation and intermediate purification of intermediates by using mild bases such as lithium hydroxide or N-methylimidazole. In the method, lithium salts can advantageously be recovered and subsequently fed back again into the production cycle. Waste generation is more advantageous compared to the prior art methods since everything is done in one “pot”, thus dispensing with workup of mother liquors, cleaning of filter apparatus, etc. By virtue of a precise determination of the ligand content prior to gadolinium complexation, gadolinium in the waste water can successfully be avoided, since the amount of gadolinium can be regulated such that all of the metal is complexed by the butrol ligand. The method can be managed with a stirrer and a filtration apparatus. Intermediate cleaning is carried out only with water; no drying is necessary and the next preparation can be carried out directly. This ensures an optimal apparatus usage and allows a semi-continuous operation. This new inventive method has succeeded in significantly reducing the preparation cost of gadobutrol once more.

The new inventive method is implemented as follows: Gadobutrol is prepared by reacting cyclen, as described in EP 0596586, with 4,4-dimethyl-3,5,8-trioxabicyclo[5.1.0]octane at temperatures of 80 to 200° C., preferably at 100-140° C., for 8-40 hours, preferably for 12-30 hours, then taking up in water and hydrolyzing the formyl intermediate by addition of 1 to 5 equivalents of lithium hydroxide at 50-100° C., preferably at 100° C., for 2-24 hours, preferably 8-16 hours, then adding chloro- or bromoacetic acid, preferably chloroacetic acid, and reacting, at temperatures of 40-150° C., lithium hydroxide, preferably 40-90° C., at a pH of 8-14, preferably at pH 9-13, over 0.5 to 24 hours, preferably for 1 to 6 hours. Subsequently adjusting to a pH of 1-4.5 with hydrochloric acid or hydrobromic acid, preferably 2.0-4.0, stirring at 20-100° C. for 0.5-24 hours, preferably for 0.5-5 hours, preferably at 30-70° C., then determining the butrol ligand content and then adding the stoichiometric amount of a gadolinium salt, such as gadolinium oxide, gadolinium carbonate or gadolinium chloride, but preferably gadolinium oxide, and subsequently stirring at 50-100° C., preferably 70-100° C. for 1 to 12 hours, preferably for 1-5 hours. After completion of the complexation, adjusting the pH to 4-8, but preferably 6-7.5, by addition of lithium hydroxide (as a solid or an aqueous solution).

Subsequently extensively concentrating under reduced pressure and optionally distilling off water azeotropically after addition of ethanol or isopropanol, preferably ethanol, at an elevated temperature of 70-80° C. Continuing the distillation as appropriate until a water content of 1-20%, preferably 5-10%, is reached. Under these conditions the gadobutrol product precipitates out, even while still hot. Then cooling down to 0-30° C., preferably 5-20° C., and filtering off the product. The still filter-damp product is dissolved from the filter with a little water at 20-60° C., preferably 20-40° C. and is finally recrystallized from ethanol. The water is optionally largely azeotroped off for this purpose, in which case the product precipitates out at the boiling temperature. The mixture is cooled to 0-20° C., the product is filtered off, washed with a little cold ethanol (preferably 0-20° C.) and then dried.

A product thus obtained is characterized by high quality and purity and corresponds to the desired requirements of the specification.

### EXAMPLE

Under nitrogen, 20 l of dimethylformamide dimethyl acetal (DMF acetal) are added to 24.0 kg (139.34 mol) of cyclen (=1,4,7,10-tetraazacyclododecane) in 200 l of toluene. The temperature is slowly raised and the azeotrope of methanol/dimethylamine/toluene is distilled off. Subsequently the solvent is completely distilled off under reduced pressure. The oil which is left behind is allowed to cool to 50° C. and then 22.44 kg (147.86 mol) of 4,4-dimethyl-3,5,8-trioxabicyclo[5.1.0]octane (content approx. 95%) are added (also under nitrogen), followed by stirring at a jacket temperature of 130° C. for 12 hours. The mixture is then cooled to 40° C. and 200 l of water and 17.53 kg (418.0 mol) of lithium hydroxide monohydrate are added.

The mixture is heated under reflux for 8 hours, then approx. 140 l of water are distilled off under reduced pressure, then cooled to room temperature and further processed.

46.66 kg (493.83 mol) of chloroacetic acid are dissolved in 50 kg of water and cooled to 5° C. To this solution are added 20.73 kg (494.1 mol) of lithium hydroxide monohydrate. The solution thus prepared is then added to the solution described above. The mixture is warmed to an internal temperature of approx. 65° C. and, at this temperature, a total of 12.0 kg (286.1 mol) of lithium hydroxide monohydrate (approx. 5-6 portions), or the equivalent amount of N-methylimidazole, is added over 2 hours. The mixture is then stirred for 1 hour at 65° C. The pH is adjusted to 1 with concentrated hydrochloric acid and stirring is continued for 30 minutes at 65° C. After cooling to 20° C., the pH is adjusted to 3.5 lithium hydroxide monohydrate, and subsequently the butrol ligand (=N-(1-hydroxymethyl-2,3-dihydroxypropyl)-1,4,7-triscarboxymethyl-1,4,7,10-tetraazacyclododecane) content is determined by HPLC against an external standard. This gives rise to a corrected content of 94.7%. Subsequently, 23.92 kg (65.97 mol) of gadolinium oxide are added and the mixture is stirred for 1 hour at 90° C. After the complexation is complete (the original suspension becomes a clear solution), the pH is adjusted to 7.0 by addition of lithium hydroxide monohydrate. Water is distilled off under reduced pressure until a viscous solution which can still be stirred is left in the stirrer. To this solution are added, at elevated temperature (approx. 80° C.), 1350 l of ethanol which is boiled under reflux for 5 hours. The mixture is cooled to 10° C., and the precipitated crystal suspension is filtered off and then washed twice with 100 l of ethanol. The filter cake, still moist with ethanol, is dissolved on the filter in 75 l of water and the solution is filtered through a filter cartridge. Then, 750 l of ethanol are added and the solution is heated under reflux for 5 hours. After cooling to 10° C. and filtering off the precipitated crystal suspension, the latter is washed twice with 75 kg of ethanol and dried under reduced pressure at 60° C.

Yield: 78.89 kg =130.46 mol, corresponding to 84.6% of theory, based on colourless crystal powder of 1,4,7,10-tetraazacyclododecane used (corrected for water and residual solvent).

Water content (Karl-Fischer): 4.12%

Loss on drying: 1.15%

Elemental analysis (corrected for water):

| Element | C | H | N | O | Gd |
|---|---|---|---|---|---|
| Calculated | 35.75 | 5.17 | 9.26 | 23.81 | 26.00 |
| Found | 35.80 | 5.25 | 9.16 | 23.73 | 25.92 |

HPLC (100% method): >99%

1. A process for preparation of a gadolinium complex of N-(1-hydroxymethyl-2,3-dihydroxypropyl)-1,4,7-triscarboxymethyl-1,4,7,10-tetraazacyclododecane, by reacting cyclen with 4,4-dimethyl-3,5,8-trioxabicyclo[5.1.0]octane and dimethylformamide dimethyl acetal, hydrolyzing a formyl intermediate by addition of lithium hydroxide, adding chloro- or bromoacetic acid and reacting lithium hydroxide or N-methylimidazole, adjusting to an acidic pH with hydrochloric acid or hydrobromic acid, subsequently determining a butrol ligand content and adding a stoichiometric amount of a gadolinium salt.

2. The process as claimed in claim 1, which comprises reacting cyclen with 4,4-dimethyl-3,5,8-trioxabicyclo[5.1.0]octane and dimethylformamide dimethyl acetal at temperatures of 80 to 200° C. and hydrolyzing the formyl intermediate by addition of 1 to 5 equivalents of lithium hydroxide at 50-100° C. over 2-24 hours, adding chloro- or bromoacetic acid and reacting, at temperatures of 40-150° C., lithium hydroxide or N-methylimidazole, and subsequently adjusting to a pH of 1-4.5 with hydrochloric acid or hydrobromic acid, then determining the butrol ligand content and adding stoichiometric amount of gadolinium oxide, gadolinium carbonate or gadolinium chloride and stifling at 50-100° C. for 1 to 12 hours.

3. The process as claimed in claim 1, which comprises reacting with 4,4-dimethyl-3,5,8-trioxabicyclo[5.1.0]octane at temperatures of 80 to 200° C., for 8-40 hours, preferably for 12-30 hours, dissolving in water and reacting the formyl intermediate by addition of 1 to 5 equivalents of lithium hydroxide at 50-100° C., preferably at 100° C., for 2-24 hours, then adding chloro- or bromoacetic acid and reacting, at temperatures of 40-150° C., lithium hydroxide or N-methylimidazole, preferably 40-90° C., at a pH of 8-14, preferably at pH 9-13, over 0.5 to 24 hours, preferably for 1 to 6 hours, adjusting to a pH of 1-4.5 with hydrochloric acid or hydrobromic acid, preferably 2.0-4.0, stifling at 20-100° C. for 0.5-24 hours, preferably for 0.5-5 hours, then determining the butrol ligand content and adding the stoichiometric amount of a gadolinium salt and stifling at 50-100° C., preferably 70-100° C. for 1 to 12 hours, after completion of the complexation, adjusting the pH to 4-8, preferably 6-7.5, by addition of lithium hydroxide, and subsequently concentrating under reduced pressure and optionally distilling off water azeotropically after addition of ethanol or isopropanol, at an elevated temperature of 70-80° C., to a water content of 1-20%, preferably 5-10%, cooling down to 0-30° C., preferably 5-20° C., filtering off a product and recrystallizing from ethanol.

4. The process as claimed in claim 2, which comprises reacting with 4,4-dimethyl-3,5,8-trioxabicyclo[5.1.0]octane at temperatures of 80 to 200° C., for 8-40 hours, preferably for 12-30 hours, dissolving in water and reacting the formyl intermediate by addition of 1 to 5 equivalents of lithium hydroxide at 50-100° C., preferably at 100° C., for 2-24 hours, then adding chloro- or bromoacetic acid and reacting, at temperatures of 40-150° C., lithium hydroxide or N-methylimidazole, preferably 40-90° C., at a pH of 8-14, preferably at pH 9-13, over 0.5 to 24 hours, preferably for 1 to 6 hours, adjusting to a pH of 1-4.5 with hydrochloric acid or hydrobromic acid, preferably 2.0-4.0, stifling at 20-100° C. for 0.5-24 hours, preferably for 0.5-5 hours, then determining the butrol ligand content and adding the stoichiometric amount of gadolinium salt and stirring at 50-100° C., preferably 70-100° C. for 1 to 12 hours, after completion of the complexation, adjusting the pH to 4-8, preferably 6-7.5, by addition of lithium hydroxide, and subsequently concentrating under reduced pressure and optionally distilling off water azeotropically after addition of ethanol or isopropanol, at an elevated temperature of 70-80° C., to a water content of 1-20%, preferably 5-10%, cooling down to 0-30° C., preferably 5-20° C., filtering off a product and recrystallizing from ethanol.

5. The process as claimed in claim 2, which comprises reacting with 4,4-dimethyl-3,5,8-trioxabicyclo[5.1.0]octane at temperatures of 80° C. to 200° C., for 8-40 hours, preferably for about 12 hours to about 30 hours, dissolving in water and reacting the formyl intermediate by addition of 1 to 5 equivalents of lithium hydroxide at 50-100° C., preferably at about 100° C., for 2-24 hours, then adding chloro- or bromoacetic acid and reacting, at temperatures of 40-150° C., lithium hydroxide or N-methylimidazole, preferably at about 40° C. to about 90° C., at a pH of 8-14, preferably at a pH of about 9 to about 13, over 0.5 to 24 hours, preferably for about 1 hour to about 6 hours, adjusting to a pH of 1-4.5 with hydrochloric acid or hydrobromic acid, preferably to a pH of about 2.0 to about 4.0, stifling at 20-100° C. for 0.5-24 hours, preferably for about 0.5 hours to about 5 hours, then determining the butrol ligand content and adding the stoichiometric amount of gadolinium salt and stifling at 50-100° C., preferably at about 70° C. to about 100° C. for 1 hour to 12 hours, after completion of the complexation, adjusting the pH to 4-8, preferably from a pH of about 6 to about 7.5, by addition of lithium hydroxide, and subsequently concentrating under reduced pressure and optionally distilling off water azeotropically after addition of ethanol or isopropanol, at an elevated temperature of 70-80° C., to a water content of 1-20%, preferably about 5% to about 10%, cooling down to 0-30° C., preferably from about 5° C. to about 20° C., filtering off a product and recrystallizing from ethanol.

6. The process as claimed in claim 2, which comprises reacting with 4,4-dimethyl-3,5,8-trioxabicyclo[5.1.0]octane at temperatures of 80° C. to 200° C., for 8-40 hours, preferably for about 12 hours to about 30 hours, dissolving in water and reacting the formyl intermediate by addition of 1 to 5 equivalents of lithium hydroxide at 50-100° C., preferably at about 100° C., for 2-24 hours, then adding chloro- or bromoacetic acid and reacting, at temperatures of 40-150° C., lithium hydroxide or N-methylimidazole, preferably at about 40° C. to about 90° C., at a pH of 8-14, preferably at a pH of about 9 to about 13, over 0.5 to 24 hours, preferably for about 1 hour to about 6 hours, adjusting to a pH of 1-4.5 with hydrochloric acid or hydrobromic acid, preferably to a pH of about 2.0 to about 4.0, stifling at 20-100° C. for 0.5-24 hours, preferably for about 0.5 hours to about 5 hours, then determining the butrol ligand content and adding the stoichiometric amount of gadolinium salt and stifling at 50-100° C., preferably at about 70° C. to about 100° C. for 1 hour to 12 hours, after completion of the complexation, adjusting the pH to 4-8, preferably from a pH of about 6 to about 7.5, by addition of lithium hydroxide, and subsequently concentrating under reduced pressure and optionally distilling off water azeotropically after addition of ethanol or isopropanol, at an elevated temperature of 70-80° C., to a water content of 1-20%, preferably about 5% to about 10%, cooling down to 0-30° C., preferably from about 5° C. to about 20° C., filtering off a product and recrystallizing from ethanol.
